(19) United States
(12) Patent Application Publication
(10) Pub. No.: US 2003/0041503 A1
(43) Pub. Date: Mar. 6, 2003

(54) Trapmaster, a carrying device for ice fishing traps and gear

(76) Inventors: Susan Beatrice Marjerison, Conway, NH (US); William Paul Hill, Conway, NH (US)

Correspondence Address: SUSAN B MARJERISON, PO BOX 2045, CONWAY, NH, 03818, US

(21) Appl. No.: 10/233,751

(22) Filed: Sep. 3, 2002

Related U.S. Application Data
(60) Provisional application No. 60/316,526, filed on Sep. 1, 2001.

(51) Int. Cl. A01K 97/04

(52) U.S. Cl. 43/54.1

(57) ABSTRACT

The Trapmaster is a complete carrying device for all of an ice-anglers tip-up traps, related gear, and extra clothing, etc. The partitioned compartments separate the traps to keep the line from becoming entangled. The backpack-style carrying straps evenly distribute the weight of the device for carrying long distances and allowing for free use of hands. The Trapmaster also rolls up and is fastened for easy, compact storage or transport. There are also hang features that allow the device to hang in an opened position for easy access to tip-ups and related gear or rolled up for compact storage.

### CROSS-REFERENCE TO RELATED APPLICATIONS

This application is entitled to the benefit of Provisional Patent Application Ser. No. 60/316,526 filed Sep. 1, 2001.

### FEDERALLY SPONSORED RESEARCH

Not Applicable

### SEQUENCE LISTING OR PROGRAM

Not Applicable

### BACKGROUND OF THE INVENTION

1. Field if Invention

This invention, hereafter referred to as either the invention or the Trapmaster, relates to ice fishing gear, specifically to an improved carrying device for ice fishing tip-up traps, hooks, line, and related tackle and gear.

### BACKGROUND OF THE INVENTION

2. Description of Prior Art

There are many different devices for carrying ice fishing gear. Usually an ice-angler will carry a number of tip-up traps, a skimmer, hooks, extra line, tackle boxes, and related gear. It is also common for an ice-angler to transport this fishing gear, while having free use of hands, to an ice house located on a frozen lake or pond. An ice-angler will also carry extra clothing such as a pair of gloves, a hat, scarf, extra sweater, etc. due to the cold nature of winter and the possibility of getting wet. Currently there are limited devices that will transport all of the needed ice fishing gear in one convenient and organized carrying device.

The first potential problem of ice fishing carrying devices is the line from the reels of the tip-up traps becoming entangled while storing or transporting. Separating the tip-up traps with partitions can solve this problem. U.S. Pat. No. 5,327,669 to Lannan (1993), U.S. Pat. No. 5,836,103 to Taylor (1996) are partitioned carrying devices, which also include a storage unit for related gear; however, they are specifically for fishing rods and will not accommodate tip-up traps. U.S. Pat. No. 5,678,348 to Ziellnski et al (1995) is also a partitioned device for fishing rods that will not accommodate tip-up traps.

U.S. Pat. No. 5,294,163 to Lang (1992) and U.S. Pat. No. D389,306 to McPherson (1996) are partitioned devices for carrying tip-up traps; however, there are no storage units for related gear. They are also hand-held carrying devices, which are undesirable for carrying long distances.

U.S. Pat. No. 5,303,500 to Luukomen (1993) is a bucket with dividers for ice fishing gear. U.S. Pat. No. 6,385,897 to Klabunde (2000) is a partitioned case for storing ice fishing equipment and related tackle. Both of these devices are cumbersome and not suitable for long distance carrying. There is also no storage place for extra clothing.

U.S. Pat. No. 5,967,315 to Langtry (1998) and U.S. Pat. No. 6,155,001 to Marin (1999) are partitioned devices with storage units for related gear. Marin's invention (1999) only shows a small pocket unit for related gear. Neither of these devices have storage room for extra clothing. They also have a shoulder strap for easier carrying and allowing free use of both hands. However, the shoulder strap doesn't distribute the weight of the device evenly across a person's back making it difficult for long distance carrying.

There are also non-patented devices that are made for carrying ice fishing traps; however, none of them have the combination of partitions for tip-up traps, storage for related gear, storage for extra clothing, ease of carrying long distances, and are convenient to store or transport.

Therefore, what is needed is a carrying device that is partitioned to avoid line entanglement from the tip-up traps, has enough storage space for related ice fishing gear and extra clothing, is easy to carry long distances, and convenient to use, store, or transport.

### BACKGROUND OF THE INVENTION

### OBJECTS AND ADVANTAGES

Accordingly, several objects and advantages of the present invention are:

(a) To provide a single device that will carry all of an ice-angler's tip-up traps, related gear, and extra clothing in an organized manner.

(b) To provide partitioned compartments to carry tip-up ice fishing traps without line entanglement.

(c) To provide storage pockets for related ice fishing gear and extra clothing

(d) To provide backpack style straps for evenly distributing the weight of the device for carrying long distances and allows for free use of hands.

(e) To be able to roll the device for easy, compact storage and transport

(f) To be able to hang the device unrolled for easy access to all tip-up traps and related gear.

Further objects and advantages of our invention will become apparent from a consideration of the drawings and ensuing description.

### SUMMARY

The Trapmaster is a complete carrying device for all of an ice-anglers tip-up traps, related gear, and extra clothing. The partitioned compartments separate the traps to keep the line from becoming entangled. The backpack-style carrying straps evenly distribute the weight of the device for carrying long distances and allowing for free use of hands. The Trapmaster also rolls up and is fastened for easy, compact storage or transport. There is also a hang feature that allows the device to hang in an opened position for easy access to tip-ups and related gear.

### DRAWINGS

### FIGURES

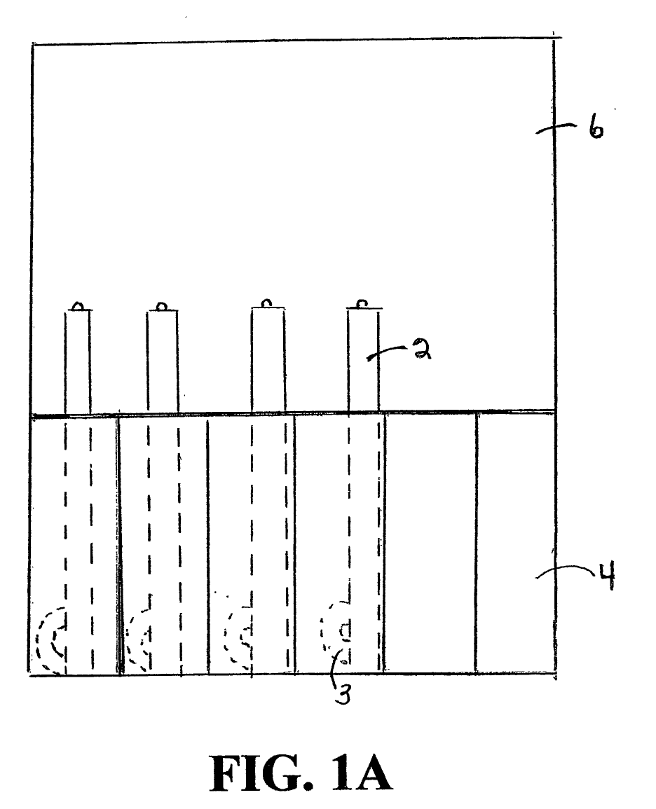

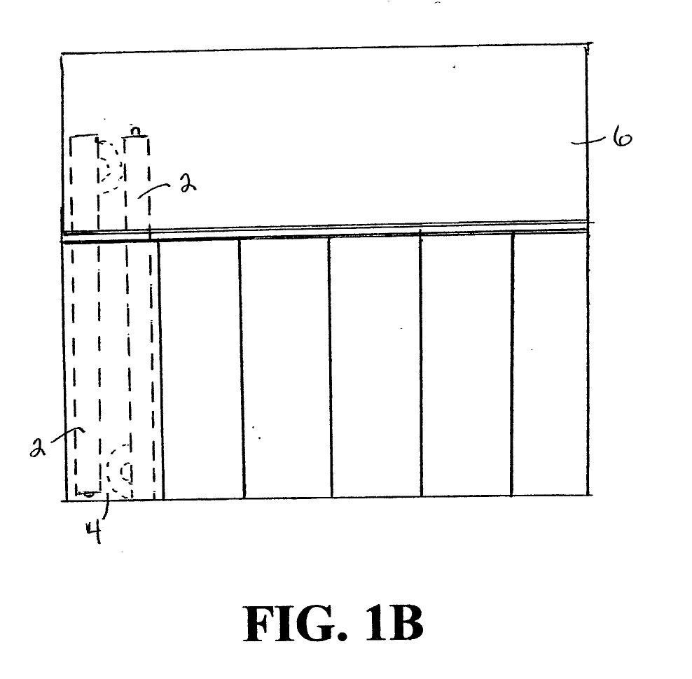

FIG. 1A is a front view of the invention showing an opened view of the Trapmaster, including the perspective view of tip-up traps in partitioned pockets.

FIG. 1B is a front view of the invention showing an opened view of the Trapmaster with the top flap folded over the tops of the tip-up traps in the partitioned pockets, including a perspective view of the tip-up traps in partitioned pockets.

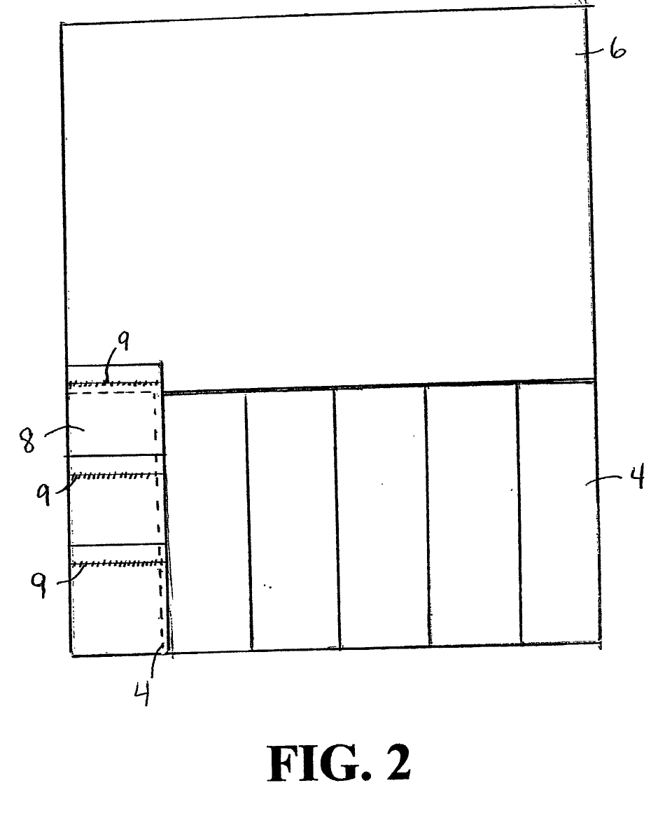

FIG. 2 is a front view of the invention showing a view of the storage pockets for ice fishing gear.

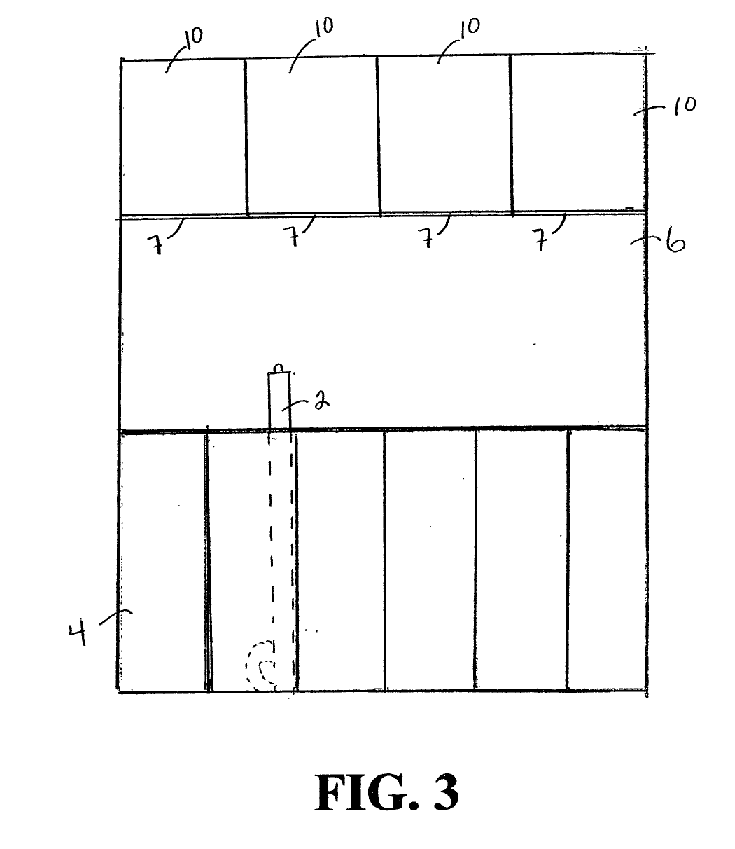

FIG. 3 is a front view of the invention showing a view of the storage pockets for extra clothing.

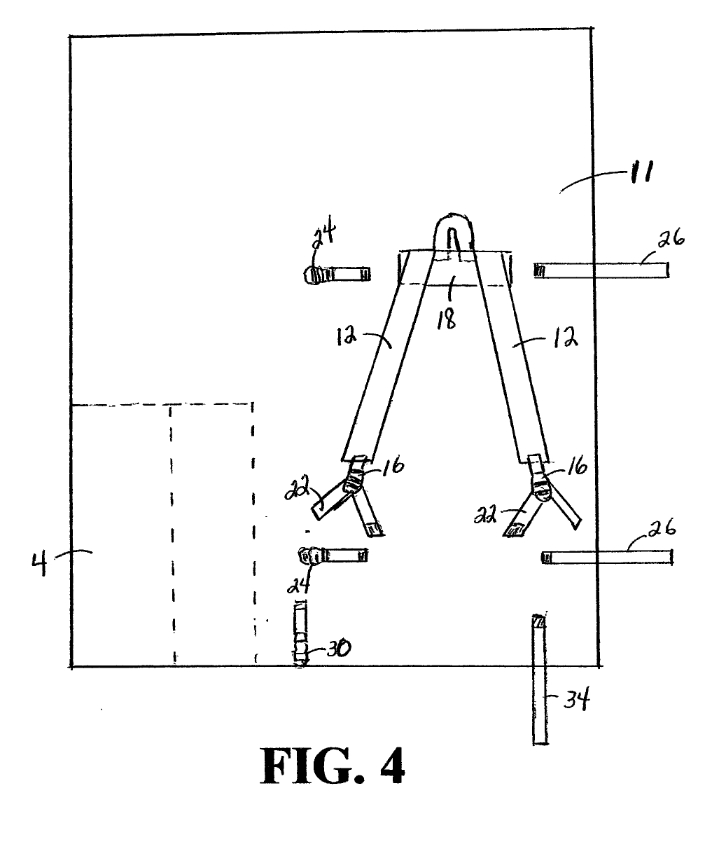

FIG. 4 is a back view of the invention showing a view of the backpack-style straps for carrying the device.

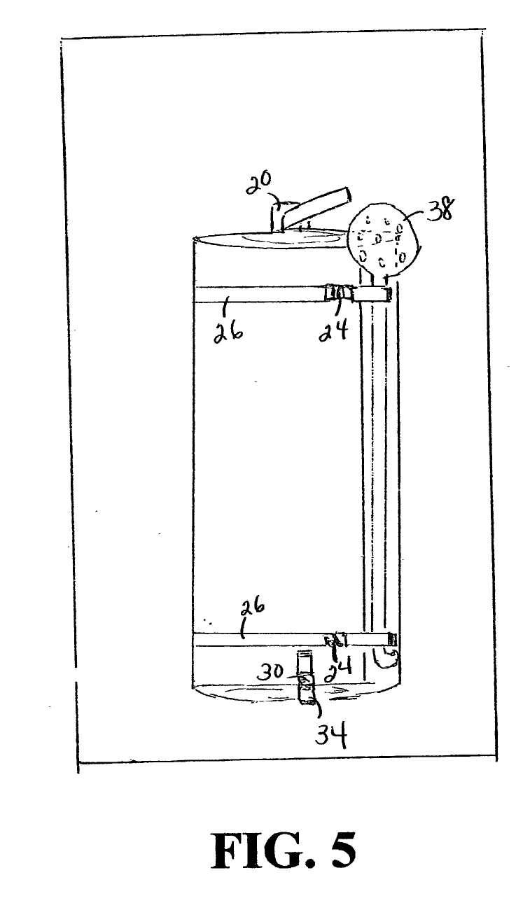

FIG. 5 is a view of the invention showing the Trapmaster rolled up and hung up for storage.

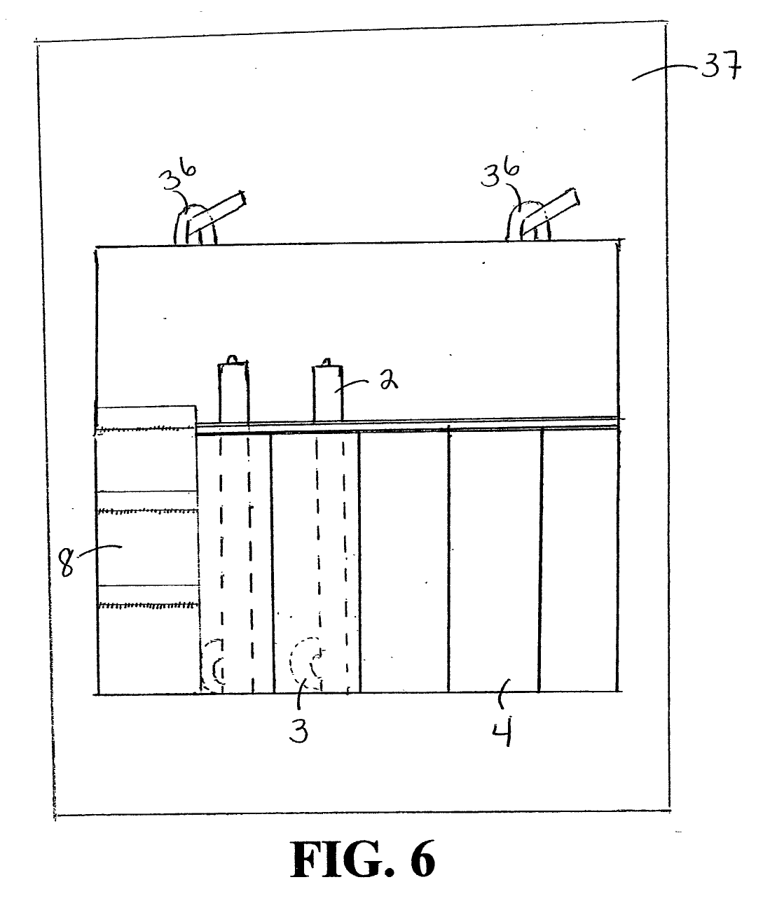

FIG. 6 is a view of the invention showing the Trapmaster unrolled and hanging for easy access to tip-up traps and related gear.

### DETAILED DESCRIPTION

### FIG. 1-6.

The Trapmaster is made from a heavy-duty fabric, namely Codura in the Preferred Embodiment. FIG. 1A illustrates the Trapmaster in an opened view. There are spaced partitions 4, which will accommodate up to twelve folded tip-up traps 2. The spaced partitions 4, also keeps the fishing line on the reel 3 from becoming entangled with the fishing line from other reels 3. FIG. 1B shows the top flap 6 folded over the tip-ups 2 to enclose and protect them. This view also shows how two tip-up traps 2 can be stored in one partitioned compartment 4.

FIGS. 2 and 3 illustrate storage compartments. The storage pocket unit for ice fishing gear 8, FIG. 2, is a set of individual compartments with either zippered 9 or velcro closures that will hold various ice fishing gear such as hooks, small tackle boxes, extra line, lures, etc. This pocket unit 8 is secured to the partitioned pocket 4. The large compartment for extra clothing 10, FIG. 3, is located in the top flap 6; it is four compartments secured to the inner main body piece 3, the compartments also have Velcro closures 7. These compartments can also be used for books, flashlights, magazines, maps, etc.

FIG. 4 illustrates the placement of the backpack-style straps 12. The straps 12 are fastened to main outer body piece 11 with 2-inch webbing 18 for added strength and durability. The straps 12 are fastened to webbing 22 with standard Ladderlock-style buckles 16. These backpack-style straps distribute the weight of the device evenly across a person's back for carrying long distances.

FIG. 5 shows the Trapmaster rolled up and secured with side buckles 24, which are standard side-release buckles, and webbing 26. There is also a bottom enclosure, standard side-release buckle 30 and webbing 34, which prevents the bottom of the Trapmaster from telescoping out of its rolled position while storing or transporting. FIG. 5B also shows the Trapmaster hanging from top loop 20 in a storage position. This figure also shows placement for an ice skimmer 38, which is another piece of related gear.

FIG. 6 shows the Trapmaster opened up and hung on the outside wall of an ice house 37 from webbing 36 for easy access to tip-up traps and related gear.

We claim:

1. A carrying device for ice fishing tip-up traps and related gear comprising:
a) a main body piece, partitioned compartments, a top flap, said body piece being rectangular in shape.
b) A storage pocket unit with at least 3 separate compartments attached to the said partitioned compartments.
c) A storage pocket unit attached to the said top flap.
d) Backpack style straps with webbing attached to the said body piece

2. A carrying device as defined in claim 1 rolls up and is secured with fasteners.

3. A carrying device as defined in claim 1 will hang in an opened state.
